(19) United States
(12) Patent Application Publication
(10) Pub. No.: US 2014/0133897 A1
(43) Pub. Date: May 15, 2014

(54) FLEXURALLY MOUNTED KINEMATIC COUPLING WITH IMPROVED REPEATABILITY

(71) Applicant: Micheal Brendan O Ceallaigh, Dublin (IE)

(72) Inventor: Micheal Brendan O Ceallaigh, Dublin (IE)

(21) Appl. No.: 13/674,119

(22) Filed: Nov. 12, 2012

(51) Int. Cl. F16C 11/04

(52) U.S. Cl. CPC F16C 11/04
USPC 403/53

(57) ABSTRACT

A kinematic coupling apparatus where mating between two objects occurs at six contacting elements, each located and oriented in compliance with the laws of kinematic design, and where each mating surface is constrained in its normal direction while having relatively high compliance in the other five degrees of freedom. The contact surfaces are preferably planar. Each coupling element is mounted on a five degree of freedom flexure, known as a stud. For maximum stiffness in three orthogonal axes, the couplings are arranged in pairs, with each pair being parallel to its twin, and orthogonal to the other two pairs. For maximum torsional rigidity, each mating pair of mating surfaces is arranged at equal and maximum distance from the center of gravity of the object being located. For highest repeatability, a positive fluid pressure is applied between the mating surfaces immediately prior to the opposing surfaces making mating contact. The precise location of the contact surfaces can be controllably adjusted to sub-nanometer accuracy by means of a linear actuator in series and collinear with the central axis of each stud.

### FIELD OF THE INVENTION

The present invention relates to kinematic couplings to enable the location and manipulation of objects with improved repeatability and accuracy.

### BACKGROUND OF THE INVENTION

The present invention is directed to kinematic couplings, particularly to such couplings comprising surfaces to exactly constrain the six degrees of freedom of a rigid body. It is also directed at kinematic couplings that need to constrain a body in fewer than six degrees of freedom. The understanding of kinematic couplings has been developed since the 1800s. The topic is fully explained in D. L. Blanding, Principles of Exact Constraint Mechanical Design, Eastman Kodak Co., 1992.

Previously, there existed two general types of kinematic couplings. Both types use three spheres or balls attached to one part which come to rest on six surfaces on the mating part. This gives nearly ideal kinematics but suffers from very high localized stresses. The first of these two types of kinematic couplings is commonly called a Kelvin Clamp. In this coupling, the three balls rest respectively in a tetrahedral socket, a vee-groove aligned to the socket, and a flat plane. The load capability of the Kelvin Clamp is typically limited by high localized stresses.

The second type of kinematic coupling is sometimes referred to as the Maxwell clamp. The reference mechanism comprises three balls sitting into three grooves. This is shown in FIG. 2a. The grooves are typically right angled, and usually set at 120 degrees to each other symmetrically about a center. As in the case of the Kelvin clamp, this type of point contact between a spherical ball and a flat surface gives rise to what is known as Hertzian contact. One difficulty with this contact is that the local Hertzian stresses are very high. Historically, this restricted the use of kinematic couplings to mechanisms for low load applications such as laboratory instruments. A number of methods have been used to attempt to overcome this problem by making the curved surfaces fit each other more closely. One method is where the grooves are manufactured as a gothic arch to increase the actual area of contact. Another method is the use of what are called ‘canoe balls’ instead of spheres. These are elements which have the same radius as a large diameter ball but comprise a small section of the large sphere. Both these methods significantly increase the load capacity and stiffness of the coupling.

In U.S. Pat. No. 6,065,898 Hale discloses a coupling that utilizes a three tooth arrangement where mating surfaces contact at a three theoretical line contacts formed by mating teeth rather than six theoretical point contacts. This is an example of what is termed a quasi-kinematic coupling. As two points form a line, conceptually, this remains close to the theoretical requirement of six constraining points, but provides a higher load capacity than six point Hertzian support. The inventor discloses that this gives, an increased load capacity analogous to the increased load capacity of a roller bearing compared to that of a ball bearing.

U.S. Pat. No. 6,193,430 discloses another quasi kinematic coupling where the mating contacts comprise a ball seating in a truncated conical hole. The contact area is greater than in the case of Hertzian point loading, and so has a high load capacity, though its repeatability is somewhat reduced as the object is over-constrained.

Repeatability in the submicron range has been reported in the laboratory for kinematic couplings. However, an ongoing problem in achieving such repeatability is that the uncertainty regarding the magnitude and direction of the sliding friction between the contacting surfaces causes the kinematic coupling to be statically indeterminate below a certain range. This range appears to be of the order of one micron. In prior art designs, the repeatability of the kinematic coupling is limited by sliding friction. Attempts to overcome this have relied on flexural bearings comprising a single degree of freedom. In U.S. Pat. No. 5,678,944 Slocum discloses a coupling where the mating contacts are mounted on a flexural bearing which can flex in the direction normal to the contact plane i.e. the axis or the single degree of freedom is normal to the contact plane. The coupling first constrains the mating surfaces in the X and Y planes, while allowing them to move in the Z direction. This is a single degree of freedom flexure with its single compliant direction normal to the contact surface of the mating elements. Another design disclosed by Schouten et al. in Precision Engineering 20, p 46-52, 1997 similarly uses a single degree of freedom flexure, but oriented in a direction orthogonal to the contact surface. This however is insufficient to give the repeatability required of modem kinematic couplings.

U.S. Pat. No. 6,746,172 discloses an adjustable kinematic coupling, where the desired accuracy is achieved by adjusting the three mating eccentric balls relative to the three grooves in which they locate. However, as there are only three means of adjustment, the object cannot be controllably moved in all six degrees of freedom.

All of the above prior art has sought to provide repeatable location to close tolerances, while accommodating high loads. However, the repeatability is limited by the impact of sliding friction, and use of a single degree of freedom flexure mounts does not overcome the problem. Therefore, there still exists a need for a kinematic coupling with improved repeatability, and with a capability of adjustment in the nanometer range in all six degrees of freedom.

### SUMMARY OF THE INVENTION

It is an object of the present invention to provide an improved kinematic coupling with improved repeatability.

Another object of the invention is to provide a kinematic coupling with increased area of contact, reduced localized stress points, and increased stiffness and load capacity.

Another object of the invention is to provide a kinematic coupling comprising a means of controllably adjusting the location of the object in each of Its constrained degrees of freedom.

Other objects and advantages of the present invention will become apparent from the following description and accompanying drawings. The kinematic coupling of this invention can be beneficially used in various applications such as in precision fixturing for tools or workpieces, and in industries such as precision machining and metrology, optics, and semiconductor industries.

### BRIEF DESCRIPTION OF THE DRAWINGS

The accompanying drawings, which are incorporated into and form a part of the disclosure, illustrate an embodiment of the invention and, together with the description, serve to explain the principles of the invention.

FIG. 1 illustrates an embodiment of the invented kinematic coupling connecting a fixed object 1a with a movable object 1b via six coupling elements using a 2-2-2 configuration.

FIG. 2a is a coupling of prior art. FIGS. 2b and 2c are invented modifications of prior art couplings.

FIG. 3a illustrates an embodiment of one half of a coupling for constraining an object in six degrees of freedom using a 3-2-1 configuration. FIG. 3b illustrates an embodiment of a coupling for constraining an object kinematically in three degrees of freedom using a 2-1-OC configuration.

FIGS. 4a 4b & 4c illustrate three coupling elements with suitable contact surfaces.

FIGS. 5a, 5b, 5c & 5d illustrate four examples of five degree of freedom flexures

FIG. 6a is an isometric view of a coupling element. FIG. 6b is an isometric view of a coupling mounting element with a cut view showing the air supply hole to a single central porous region. FIG. 6c is an isometric view of a coupling mounting element with a cut view showing the air supply holes connecting to two porous regions.

FIG. 7 illustrates the deflection of a flexure, where δ is the deflection of the flexure, and ε is the parasitic deflection in the axial direction.

### DETAILED DESCRIPTION OF THE INVENTION

The kinematic couplings of this invention conform to the rules of kinematic design which are summarized as follows: By definition, an unconstrained object has 6 degrees of freedom. It has a translational degree of freedom along each of three reference orthogonal axes. It also has a rotational degree of freedom about each of the same three axes. For an object to be kinematically constrained, each degree of freedom must be exactly constrained. To effect this, the object must be constrained at exactly six points, and no constraining point may be redundant. If the body is constrained at more than six points, then it is over-constrained. The rules governing redundancy are simple and well understood by those skilled in the art: for instance, no three points may lie in a single line, and no four or more points may lie in a plane. Combinations of constraints are similarly restricted. They can be best understood by examining the planes of contact at each contact surface.

The points of contact restrict the six degrees of freedom of a rigid body in two basic configurations. The first is hereby termed a plane-line-point or 3-2-1 configuration. The second is hereby termed a line-line-line or 2-2-2 configuration. In the 3-2-1 configuration, the contact planes at three points form a first reference plane, the contact planes at two points form a second reference plane orthogonal to the first, and the final point forms a third reference plane, orthogonal to the other two. It should be understood that a component of the contact planes of three points may form the above reference planes, rather than the contact planes themselves. The difference between the two configurations is only absolute when the contact planes themselves are parallel to the orthogonal reference planes derived above. It is readily understood from the above, that only 3-2-1 and 2-2-2 configurations satisfy the conditions that (a) the total number of constraints must add to six, and (b) no plane may have more than three constraints, and (c) each plane must have at least one constraint. All kinematic couplings conform to the above rules, as do the embodiments of this invention. For the following invention, a coupling will be treated as kinematic if it satisfies the above design rules, even if the area of contact at each location is greater than that of a single theoretical point.

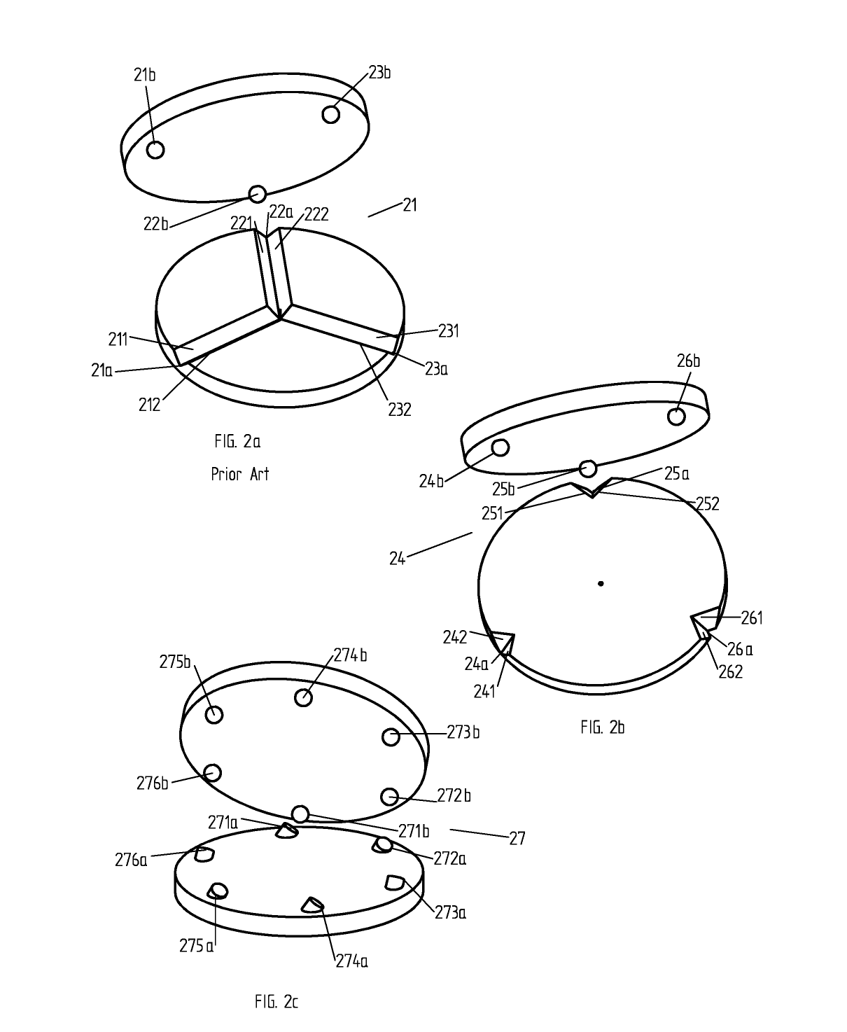

Earlier designs of kinematic couplings have contact planes that are not orthogonal. The prior art coupling shown in FIG. 2a is one such design. This is a significant disadvantage for prior art couplings as it significantly increases the negative impact of sliding friction on the repeatability of the coupling. Studies have shown that the limiting friction i.e. the Motion above which the coupling does not close, is as low as 0.319. FIG. 2b snows an Invented coupling which reduces the effect of such friction. It has three grooves 24a, 25a and 26a in which balls 24b 25b and 26b locate. Groove face 261 in groove 26a is coplanar with face 242 in groove 24a. Similarly, groove face 241 in groove 24a is coplanar with face 252 in groove 25a. Groove face 251 in groove 25a is coplanar with face 262 in groove 26a. The three planes are orthogonal to each other. It should be noted that the angle each plane to the horizontal is 54.73°, hereinafter known as the Carrickfergus angle, called after the town of the same latitude. FIG. 2c shows a still further invented improvement. Contact faces 271a and 274a are coplanar, faces 272a and 275a are coplanar, and faces 273a and 276a are coplanar. Each pair is symmetric about the centre of the coupling. This increases the torsional rigidity of the coupling and further reduces the negative impact of sliding friction on the coupling's repeatability. However, this invented coupling still suffers from the negative impact of sliding friction, albeit to a lesser extent than prior art couplings.

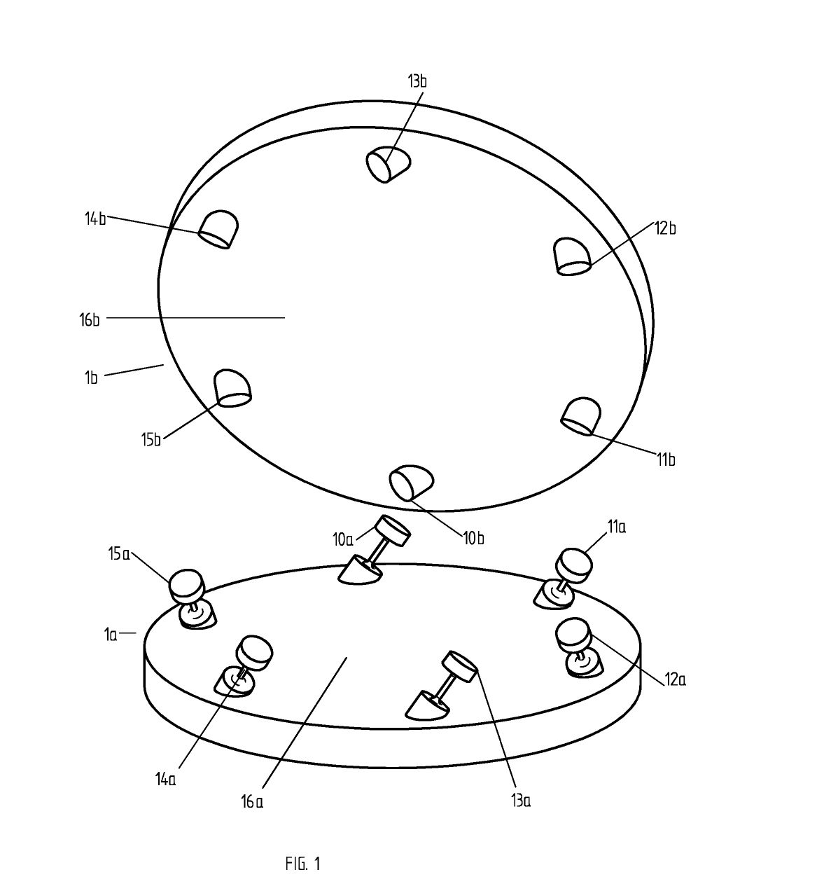

Referring now to FIG. 1 which illustrates a preferred embodiment of this invention, the coupling comprises of two halves 1a and 1b. Coupling half 1a comprises a coupling plate 16a and six coupling halves 10b, 11b, 12b, 13b, 14b, and 16b. Coupling half 1b comprises a coupling plate 16b and six coupling halves 10b, 11b, 12b, 13b, 14b, and 15b. The fixed coupling half 1a mates with the moving coupling half 112 via these six coupling elements. Each coupling element half 10a, 11a, 12a, 13a, 14a, and 15a on 1a—mates with its corresponding half—10b, 11b, 12b, 13b, 14b, and 15b of the moving coupling 1b. In practice, one half may, for instance, be attached to a machine, and the other attached to a part to be machined. These terms are used for illustration only. It should be understood that both coupling halves may be moved, as for instance when two parts are mated to form an assembly. The flexures may be attached to either the fixed or moving halves, or both. Hereinafter, the terms fixed half and moving half will be used.

The essential design feature of this invention is that each contact surface supports the opposing surface with high rigidity only in the direction normal to its canted surface, and in contrast, is designed to be relatively compliant in the orthogonal directions, and about all rotational axes. Hereinafter, the direction normal to the contact surface shall be referred to as the coupling element's axial or Z direction, and directions orthogonal to it are hereinafter called the coupling element's X and Y axes. Thus, compared with its Z axis, the coupling elements contact surface is relatively free to move translationally in the X and Y directions, and rotationally about the X, Y and Z axes. This relative compliance is provided by a flexure with five degrees of freedom.

With reference to a 2-2-2 configuration shown in FIG. 1, each stud axis is oriented at the Carrickfergus angle of 54.73° to the horizontal plane. While it is not essential that the contact surfaces of this invention be orthogonal, it is still advantageous. Three dimensional accuracy and repeatability and stiffness are enhanced when the contact planes are orthogonal. Furthermore, the torsional stiffness of the coupling is increased when the studs are located symmetrically about the centre of gravity. In some applications of this invention, the requirement for accuracy or stiffness in one dimension may be higher than in others, and it may be beneficial to have non-orthogonal contact planes.

One can understand how the coupling operates by examining the operation of a single coupling element half 10a with its mating half 10b. At the point where they mate, there will be what is hereinafter caned a placement error in the X and Y directions. The Z axis is however fixed with a high degree of precision. When coupling element halves 13a and 13b similarly mate, the coupling is referenced translationally in the Z axis, and rotationally about the Y axis. It is still relatively free to translate in the X and Y directions. The contact surface planes are also relatively free to rotate about the X and Y axes in order to orient to be fully parallel with each other.

When coupling element halves 11a and 14a mate with their corresponding halves 11b and 14b, the coupling is referenced translationally in the X axis, and rotationally about the Z axis. When coupling element halves 12a and 15a mate with their corresponding halves 12b and 15b, the coupling is similarly referenced translationally in the Y axis, and rotationally about the X axis. The coupling is then fully coupled in all six degrees of freedom.

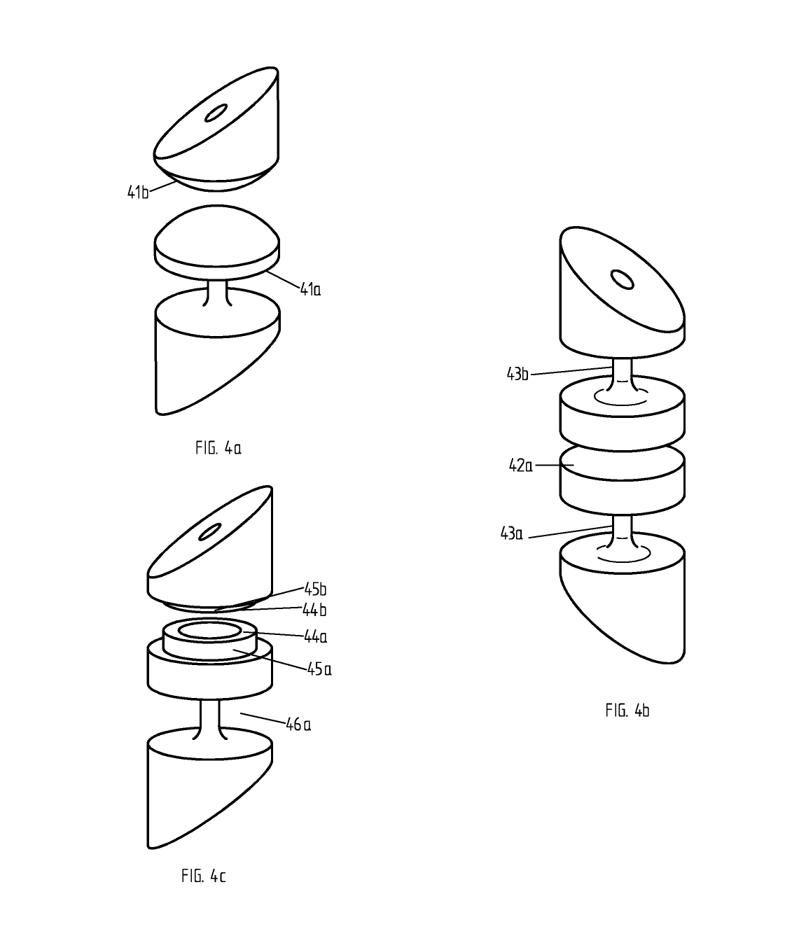

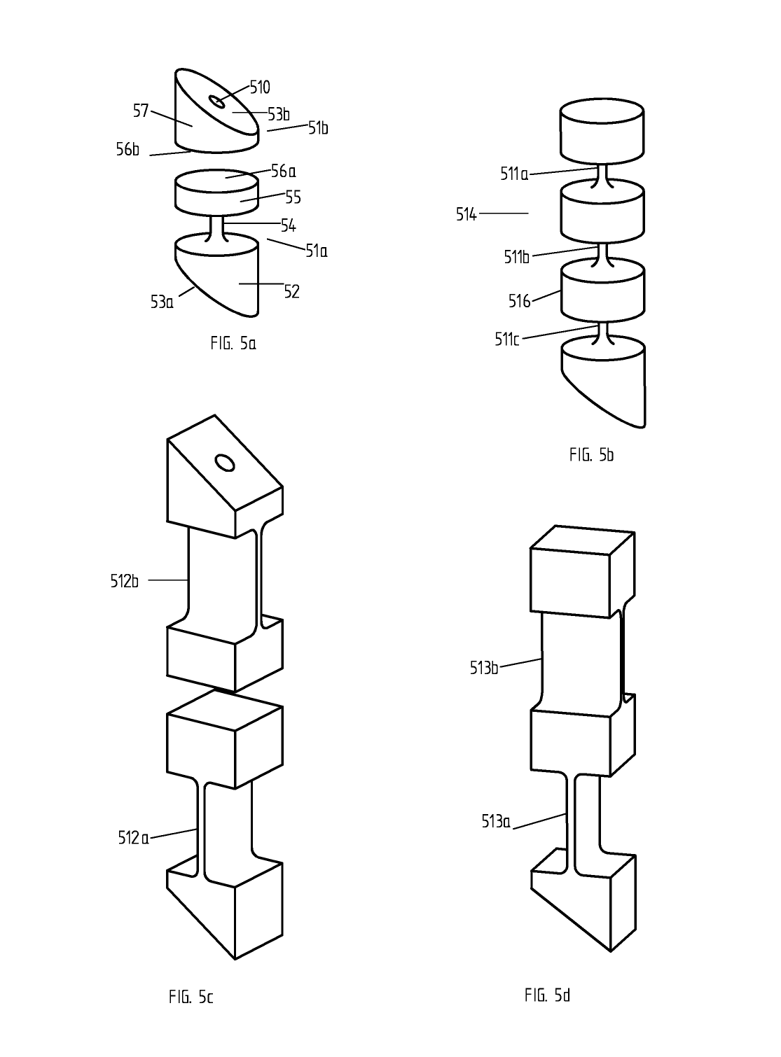

A number of different designs of five degree of freedom flexures exist. The simplest form is a rod where the length is greater than its diameter. Such flexures are commonly referred to as wire flexures. This term is not used in this application as it may imply that the flexure has low axial stiffness and is thus unsuitable for use in compression, which is not the case. Instead, the five degree of freedom flexures used in this invention are referred to hereinafter as studs. Four different embodiments of studs are illustrated in FIGS. 5a, 5b, 5c and 5d. The stud 51a is comprised of a rotationally symmetrical shaft 54, connecting a bottom mounting region 52 with a mounting face 53a to an upper contact region 55 with a contact face 56a. The stud 51a is manufactured as a monolith. The other half of the contact element is the lug 51b, with its contact surface 56b and mounting surface 53b. To effect accurate and repeatable coupling, the contact region 56a mates securely with the contact region 58b. The coupling element halves may be mounted using simple screws to the threaded hole 510. The mounting faces 53a and 53b align to the coupling plates within normal engineering workshop tolerances. Adhesives are also highly suitable for mounting the elements. FIG. 4c shows an embodiment where the stud 46a is comprised of a steel stud with a silicon nitride contact surface element 45a adhesively attached to it. Potting methods, such as those used for mounting air bearings, and known to those skilled in the art are also suitable.

White rotationally symmetric designs are common, other shaped designs can also be employed. FIG. 5c and 5d show examples of rectangular flexures. Those skilled in the ad will also recognise that a five degree of freedom flexure can comprise a number of lower order degree of freedom flexures attached in series. FIG. 5d shows a monolithic five degree of freedom flexures comprising a first plate flexure 513a with three degree of freedom in series with, but oriented at ninety degrees to a second plate flexure 513b. FIG. 5c shows a similar configuration, with the plate flexures 512a and 512b on either side of the contact surface.

Two five degree of freedom flexures when mounted in series, with their axes collinear, combine to be a five degree of freedom flexure. FIG. 5b shows an example of this stacked flexure where stud 514 comprises three flexures 511a, 511b and 511c. This stacking rule applies even when such flexures are attached to either half of the coupling element as shown in FIG. 4b where flexures 43a end 43b are in separate coupling halves. These rules for combining flexures are already well understood by those skilled in the art. Hereinafter, the term stud will encompass all combinations of flexures that combine to give five degrees of freedom to the mating surfaces, such that the stiffness of the coupling element in the direction normal to the mating surface is substantially higher than the stiffness in all other directions.

The relative difference in the stiffness of the stud in the axial direction compared with the orthogonal directions is designed to suit the application. For instance, for a cylindrical stud with a length 10 times greater than its diameter, the stiffness ratio of X to Z direction stiffness is about 1 to 133. Where a contact element is mounted on the stud this ratio is increased. For instance, if the contact element is the same length as the stud, the stiffness ratio is increased to about 1 to 300, or 0.3%. This is hereby termed an orthogonal resistance factor. Those skilled in the art will recognise that this is equivalent to the friction factor in a coupling limited by sliding friction. Sliding friction values of prior art couplings are typically in the range of 10% to 20% or higher. A variation in the axial load on the stud leads to a variation in the axial strain of the coupling interface of that coupling element, and thus to a variation in the location of the coupled object. An important influence on the repeatability of this invented coupling is that most of the axial load at each coupling interface is carried axially by that supporting stud, and that this amount should not vary except within allowable tolerance. Only a small proportion, of consistent magnitude, of that load is carried by shear or torsional loading of any of the other orthogonal studs. The stiffness of the stud and the mating procedure is designed to achieve this. This invention provides for the reduction in the orthogonal resistance factor by two orders of magnitude or more, with a resulting significant improvement in the coupling's repeatability.

The dimensions of the stud can be designed according to normal engineering principles. Many applications require couplings with a high torsional stiffness as well as linear stiffness. To maximise the torsional stiffness of this invention the studs are placed at the maximum distance from the centre of gravity. For dynamic applications, the coupling design can be optimized to provide a high resonant frequency using shorter shaft studs with smaller diameters. Finite Element Analysis is particularly useful for estimating the numerous design parameters that need to be considered such as the normal load that the stud can accommodate, the factor of safety relating to any given loads or deflections, the stresses induced by any given deflection, and the stiffness of the stud in all directions. It should also be noted that the stud of this invention can be designed to be used in tension as well as compression, as required by the particular application, and that each of the six studs need not be of the same design. The couplings may be subject to different types of loads with some in tension, and others in compression, as is the case where the coupling is used to support an overhanging load. The location of the coupling elements and the orientation of their axes can be adapted to optimally couple parts subject to off-centre loads, torque loads, or overhanging loads. In general, for maximum three dimensional repeatability it is desirable to design the coupling elements' location and orientation to support the loads evenly across the six coupling elements. As with all product design, other design objectives and restrictions influence the coupling design.

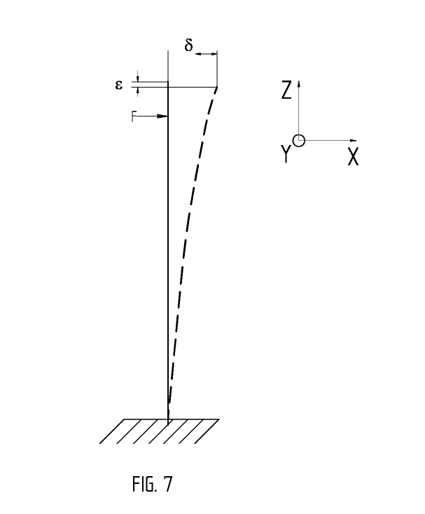

FIG. 7 is a representative drawing of the deflection of a stud when referencing in directions orthogonal to the rods of the stud. The drawing is not to scale, but this concept is shown in numerous sources such as U.S. Pat. No. 6,688,183. When referencing in the X direction, the Z axis stud deflects by an amount δ in the X direction to accommodate such referencing. This is hereby called referencing deflection. This referencing deflection however gives rise to a separate deflection in the axial direction commonly referred to as parasitic deflection. This is conventionally represented by the letter ε and is shown as such in FIG. 7. For small deflections, the ratio of referencing to parasitic deflection is several orders of magnitude. For instance, for a stud 10 mm tong that deflects 10 microns in the X axis to accommodate referencing, the parasitic deflection in the Z axis is less than about 0.1 nm. Thus, it can be seen that the stud can constrain an object accurately and repeatably in its axial direction, and this is largely unaffected by deflection or low stiffness in its orthogonal directions.

The contact surface geometries of kinematic couplings known to date are typically composed of balls or cylinders mating to suitable flat or curved surfaces. One such prior art coupling is shown in FIG. 2a where coupling is effected by three balls 21b, 22b and 23b sealing in three corresponding grooves 21a, 22a and 23a. Such curved contact surfaces may also be used with this invention. FIG. 4a shows a coupling element 41 where curved contact surface 41b references against curved contact surface 41c at a point in line with the stud's axis. However, a disadvantage of this design is that it results in Hertzian contact with resulting high localized stresses. Furthermore, it is typically more difficult and more expensive to achieve the required surface geometries and finish on the mating surfaces, and such surfaces are more prone to wear. Instead, flat surface contacts are preferred because of their higher stiffness end better geometric accuracies, lower production cost and because they make a mating contact with each other. The contact area of the preferred flat surface should preferably be larger than the cross-sectional area of the stud on which it is mounted, as shown in FIG. 4b where the contact surface area 42a is larger than the cross-sectional area of the stud 43a. Annular contact areas 44a and 44b are also highly suitable as shown in FIG. 4c. The contact surface element 45a and its mating opposite 45b may conveniently be manufactured as separate elements as shown, and which are attached to the stud. The flat surfaces required should be large enough so that they easily mate with the opposing surface. For highest repeatability, the material should have a high hardness, and be machined to a high degree of flatness, and a low surface roughness.

For mating contact of two flat surfaces, it is instructive to refer to the use of gauge blocks. Reference gauge blocks are lapped to high flatness and surface roughness standards, and are brought together in a process known as ‘wringing’. The length of a gauge block is taken as the length of the material plus the length of this wringing layer. The wringing layer is typically about 25 nm, and is generally stable to within a few nanometers under controlled conditions. In this invention, the dimensional stability and repeatability of each mating contact surface to the other is the key limitation on the repeatability of the coupling. As shown by the case of gauge blocks, this can be as low as a few nanometers under controlled conditions. It should be noted that this is two to three orders of magnitude lower than the locating repeatability of contact surfaces which are subjected to sliding friction.

While the above-mentioned gauge blocks are rectangular in shape and may be used, generally rotationally symmetric designs are preferred for this invention because of their ease of manufacture and symmetric stress distribution profiles. Preferred materials used for the contact surfaces are stainless steels and ceramics and superhard materials such as polycrystalline diamond. Ceramic faucet (tap) washers are similar in dimension and machining tolerance to the contact surfaces of this invention, and are manufactured in high volumes and at low cost. Similar materials and production processes may be used to manufacture the contact surface elements of this invention. In some applications the materials used for coupling may be restricted. For instance, inver or Super inver may be required due to their low co-efficient of thermal expansion and may be used in this invention.

The stud typically incorporates a wider section at either end. The wider ends may be used to attach the stud to one of the objects or to attach a separate contact surface element. This is the case where the stud is constructed from metal, such as stainless steel or aluminium, and the contact areas are constructed from ceramic, such as silicon nitride. Normal engineering means may be employed to attach the stud to objects and to the Contact surface element. Adhesive means can be used, as the thin layer has very little impact on the total axial rigidity of the stud.

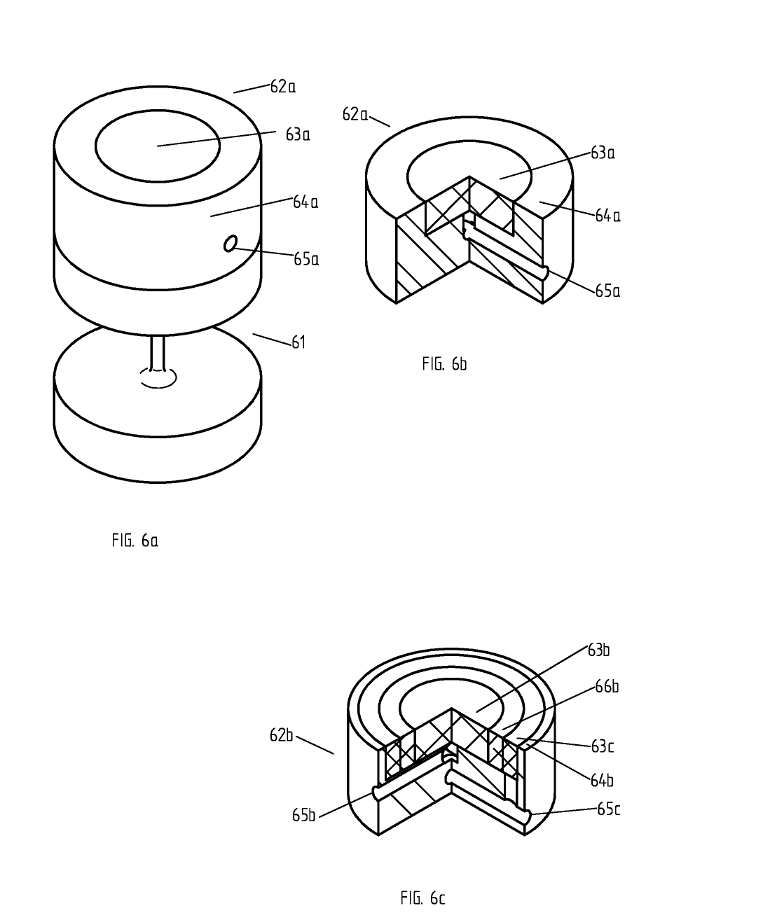

It is preferred to have a controlled method of clamping of the two opposing surfaces of each coupling element. In some cases, gravity loading is sufficient, but vacuum clamping may also be usefully used. FIG. 6a shows an isometric view of a coupling element half used for this purpose. FIG. 8b shows an Isometric view with a cut out quadrant of the contact element portion 62a detailing the vacuum supply. A metal casing 64a contains an inner region 63a which is permeable to air. The favoured material is porous graphite. Vacuum is supplied via a hole 65a in the casing. For highest accuracy, this hole is a symmetric through hole with a vacuum supply at both ends resulting in no net sideways force being applied to the coupling element. Applying a vacuum in a controlled manner forces the two opposing surfaces together, causing their surfaces to align parallel, and in intimate mating contact. The repeatability of this alignment is thought to be in the order of a few nanometers, similar to that of standard gauge blocks. The vacuum may be applied initially to close the coupling and then released, or it may be held continuously as a clamping force. For coupling of lighter parts, and for dynamic applications, a constant vacuum force may be usefully applied. A liquid may be usefully applied to the clamping surfaces before clamping to give a consistent meting layer thickness. Positive pressure may be applied to release the coupling.

The distance between the point where each coupling surface initially seats with its partner and the point where it is fully supported influences the repeatability of the coupling. With careful placement, all six couplings will seat substantially simultaneously. However, for maximum repeatability, the invention shown in FIG. 6a is used. FIG. 6a shows a stud 61 with a surface element 62a mounted on top which acts as an air bearing during the mating process. The surface element 62a comprises a porous graphite region which is permeable to air, and fixed in a steel casing 64a. A positive pressure is supplied though the hole 65a to the porous surface region 63a. A section view of me surface element 62a Is shown in FIG. 6b for illustration. As the moving object is placed in proximity to the fixed object, each of the coupling elements' six surfaces approaches its mating partner. The pressure is set at a level to prevent the moving object touching down at any of the six locations. Instead, it rests at a distance determined by the equilibrium fly height of the air pressure supplied by the air bearings. This can typically be in the range of one to ten microns. In this way, each stud is fully loaded axially, but is not subject to sideways or twisting loads. The axial strain of the flexure is the same as when the coupling is clamped. The air pressure is then reduced, leading to a reduced fly height of the air bearing, and then causing the coupling surfaces to touch down, as the weight of the object exceeds the upward force from the air. If desired, a vacuum force may then be applied via the hole 65a to clamp the coupling. This nesting procedure is highly repeatable as the studs are fully strained axially before any of the six surfaces touch down, and touching down at each location is repeatable to about one micron. Overall coupling repeatability is improved as a result.

FIG. 6c shows a surface element 62b with two porous regions 63b and 63c, along with a ceramic contact surface 66b and all adhesively bonded into a steel casing 64b. Air is supplied to porous region 63b via symmetric through hole 65b, and air supplied to 63c via symmetric through hole 65c. This design gives added control over the mating process for light weight parts or where gravity acts to oppose coupling, as positive air pressure can be applied in one porous region while simultaneously applying vacuum to the other. Reducing the relative force from the air pressure causes the coupling surfaces to mate. Because of the high modulus of the ceramic, it carries practically the entire load of the coupling. Typically when polished as a single assembly, the surface of the softer graphite regions are marginally recessed under the ceramic surface, but this is not a detriment to the operation of the bearing.

The above air bearing, and their design and manufacture are well understood by those skilled in the art. If using a porous material as shown, porous graphite with 10 to 20% open porosity is highly suitable. Alternative designs do not use a porous material but instead use one or more holes and channels to provide the air flow. White air is referenced here as the fluid of choice, it should be noted that applying a liquid such as water or oil to the opposing surfaces prior to mating provides a temporary fluid bearing and can be advantageously used in certain applications. Those skilled in the art will also recognise that a permanent magnets can be replace one of the porous regions to good effect.

There can be a need to adjust the location of objects even when placed to nanometer accuracy. The advantage of this invention is that the length of each stud may be readily adjusted in a controlled manner, and by doing so controllably moves an object in six degrees of freedom. Several linear actuators with sub-nanometer resolution are known to those skilled in the art, are suitable for the task. They are described in Foundations of Ultraprecision Mechanism Design by S. T. Smith & D. G. Chetwynd p 202, CRC Press, 1992. As each coupling element acts in a single axis only, a linear actuator can be easily integrated with each element to give adjustability in six degrees of freedom.

Modem piezoelectric transducers are well suited to this task. A piezoelectric transducer is mounted in series with each stud, with its axis of action collinear with the eats of the stud, and a voltage applied to it. The desired adjustment can be made with resolutions of less then one nanometer. Poisson ratio actuators may be used and integrated into the coupling element. For instance, referring to FIG. 5b, a pressure can be applied to the radial region 516 by hydraulic means. This results in a relatively small increase in the axial length of the stud in accordance with its Poisson Ratio. For example, when a 1 Bar pressure is applied to the circumference of a stainless steel coupling element of 40 mm diameter and 10 mm in length, the element increases in length of about 5 nm. Thus controlling the pressure to 0.1 Bar gives 0.5 nm movement steps in the location of each coupling element contact surface.

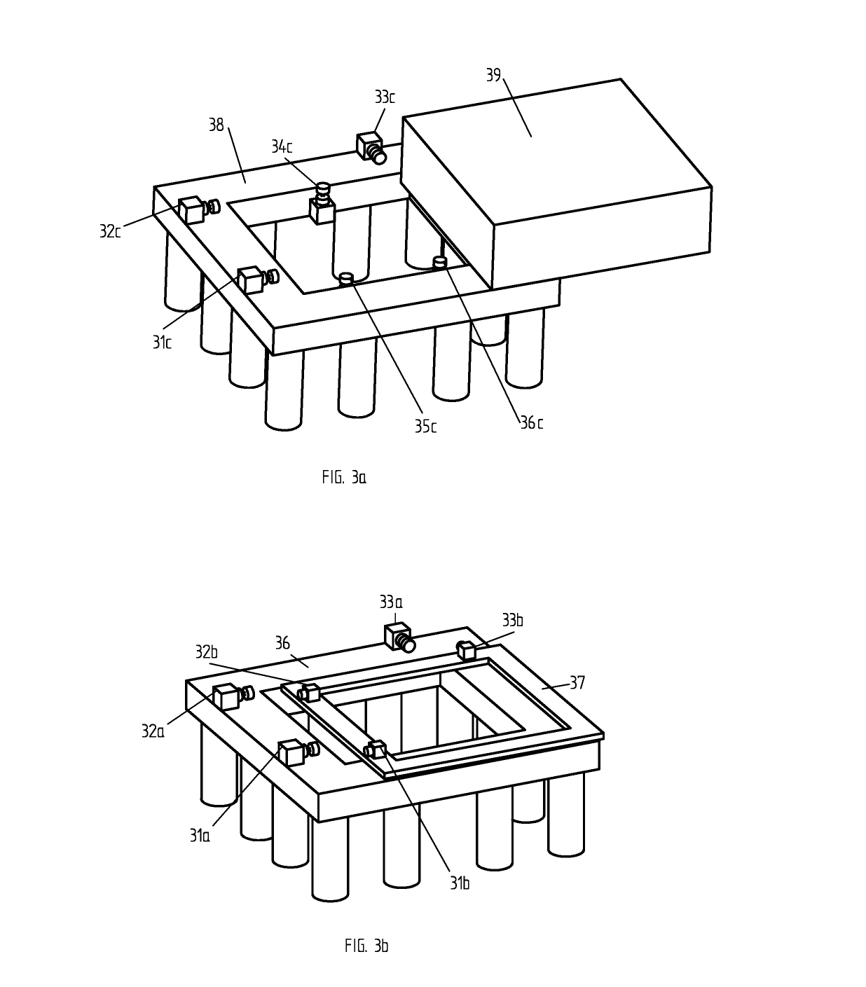

Referring to FIG. 3a, this invention can also be usefully employed in a 3-2-1 configuration to kinematically couple a moving object 39 to a fixed object such as the machine bed 38. The three coupling halves 34c, 35c and 36c are oriented parallel to the Z axis, 31c and 32c are oriented parallel to the X axis, and 33c is oriented parallel to the Y axis. The contact surfaces mate directly with the orthogonal surfaces of the object itself.

Referring to FIG. 3b, this invention can also be usefully employed where an object is to be kinematically coupled in fewer than six degrees of freedom. For example, it is very usefully employed where an object may need to be supported in an over-constrained manner in the Z axis on a table, but located accurately in the X and Y directions, and oriented accurately about the Z axis. This is hereinafter known as a 2-1-OC configuration. Many applications, such as precision machining or metrology, or fabrication involve the location of an object with high repeatability against a flat surface, and with a given orientation. FIG. 3b shows a rectangular machine table 36 incorporating three coupling element halves 31a, 32a and 33a. Coupling element halves 31a and 32a are oriented substantially parallel to the X axis, and coupling half 33a is substantially parallel to the Y axis. The coupled object is a rectangular shaped flat object 37, hereinafter called a frame incorporating three mating coupling element halves 31b, 32b and 33b. The frame is mounted on the table, and is located with its coupling element babies proximate to the mating halves on the machine. The frame is secured to its reference surfaces by applying a vacuum through the machine reference surfaces. Typically a temporary fluid layer will be formed between the frame and the table during the referencing procedure in order to prevent friction influencing the referencing accuracy. It is then secured to the table in the Z direction. The frame is thus aligned with nanometer precision in the X, Y and about the Z axis.

It has thus been shown that the present invention provides an improved kinematic coupling which increases the repeatability over the prior known couplings. White particular embodiments of the invention have been illustrated, they are not intended to be limiting. Modifications and changes may become apparent to those skilled in the art, and it is intended that the invention be limited only by the scope of the appended claims.

What is claimed is:

1. A kinematic coupling for repeatedly locating two objects relative to each other with precision, such that
a. the coupling comprises at least three coupling elements located at an equal number of separate locations, where each coupling element comprises two mating components with opposing contact surfaces; and where
b. each coupling location is selected to conform to the rules of kinematic design; and where
c. each coupling element is mounted on a flexure with five degrees of freedom, such that the stiffness of the coupling element in the direction normal to the coupling surface is substantially higher than the stiffness in all other directions.

2. The kinematic coupling of claim 1 where the number of coupling elements is six

3. The kinematic coupling of claim 1 where the contact surfaces of the coupling elements are substantially planar.

4. The kinematic coupling of claim 2 where the six coupling elements comprise of three twinned pairs and where the contact planes at each coupling element surface is substantially parallel to the contact plane of its twin, and substantially orthogonal to the contact planes of the two other pairs.

5. The kinematic coupling of claim 4 where the contact plane of each coupling element is substantially coplanar with the contact plane of its twin.

6. The kinematic coupling of claim 5 where the three orthogonal contact planes each form an angle substantially equal to the ideal orthogonal angle of 54.73° to the horizontal plane, and each at 120 degrees relative to each other about the horizontal plane.

7. The kinematic coupling of claim 2 comprising of six coupling elements, such that each coupling element comprises of two mating halves with opposing planar contact surfaces, and where at least one coupling half has a region on the contact surface that is permeable to fluids, and has at least one orifice connected to said permeable region through which said fluid can pass.

8. The kinematic coupling of claim 1 with a fine adjustment mechanism whereby each coupling element contains a linear actuator in series with the flexure, and whose axis of action is substantially collinear with the axis of the flexure.

9. The kinematic coupling of claim 1 which is used to locate an object in a single reference plane, and to orientate it about that reference plane, and where the number of coupling elements is three, and where the axes of the flexures on which the three coupling elements are mounted are all are all substantially parallel to the said reference plane.
